(19) United States
(12) Patent Application Publication
(10) Pub. No.: US 2022/0339758 A1
(43) Pub. Date: Oct. 27, 2022

(54) METHOD FOR TREATING WOODEN BARRELS USING A GRIT-BASED AND/OR SLAG-BASED ABRASIVE, AND TREATMENT DEVICE FOR IMPLEMENTING SAME

(71) Applicant: ALTER EGO, LE BOUSCAT (FR)

(72) Inventor: Jean-Luc DUTEL, LE TAILLAN MEDOC (FR)

(21) Appl. No.: 17/762,843

(22) PCT Filed: Jun. 23, 2020
(86) PCT No.: PCT/EP2020/067559

§ 371 Date: Mar. 23, 2022

(30) Foreign Application Priority Data
Sep. 25, 2019 (FR) FR1910567

(51) Int. Cl. B24C 1/08; B24C 3/32; B27H 5/08

(52) U.S. Cl. CPC B24C 1/086; B24C 3/325; B27H 5/08

(57) ABSTRACT

A method for treating wooden barrels, including a step of spraying a grit-based and/or a slag-based abrasive onto at least one portion of the inside surface of a wooden barrel to remove a damaged layer to separate the grit and/or slag from other residues.

### CROSS-REFERENCES TO RELATED APPLICATIONS

This application claims the benefit of the International Application No. PCT/EP2020/067559, filed on Jun. 23, 2020, and of the French patent application No. 1910567 filed on Sep. 25, 2019, the entire disclosures of which are incorporated herein by way of reference.

### FIELD OF THE INVENTION

The present invention relates to a method for treating wooden barrels using a grit-based and/or slag-based abrasive, and a treatment device for implementing same.

### BACKGROUND OF THE INVENTION

According to one procedure, wine is aged in wooden barrels. For the present application, a wooden barrel is understood to be any wooden container, such as, for example, a barrel, a cask or the like.

The aging of the wine in a wooden barrel leads to a progressive alteration of the inside surface of the barrel, to a depth of a few millimeters, by microorganisms and by a build-up of organic and mineral deposits.

This alteration leads to a reduction, even an elimination, of the gaseous exchanges between the wine and the outside of the barrel and at least partially prevents the wood from releasing various substances that it contains into the wine, such as, for example, aromas or tannins.

To be able to reuse wooden barrels, the document WO 2007125250 proposes a method for restoring wooden barrels consisting in spraying onto the inside surface of the wooden barrel a mineral abrasive, such as silica, with a granule size of between 400 and 2000 μm.

To spray the mineral abrasive against the inside surface of the wooden barrel, a hose is introduced into the wooden barrel via the bung hole. This hose is set in motion such that the abrasive jet leaving its end sweeps the entire inside surface of the wooden barrel. The abrasive is propelled with water and/or air at a pressure of the order of 5 to 15 bar, with an abrasive percentage of the order of 15 to 40%.

At the end of this step, the residues from the treatment, namely essentially the abrasive, the wooden fibers, the microorganisms and the deposits, are discharged by gravity and rinsing with cold water.

This method for treating wooden barrels is effective and allows them to be reused for aging wine or for storing other alcohols.

However, the silica grains have a tendency to fragment on contact with the wood and to pass between the staves of the wooden barrel thus generating a cloud of dust outside the wooden barrel. Even if it is possible to contain it during the treatment, by covering the wooden barrel with a cap for example, this cloud of dust spreads as soon as the treated wooden barrel is discharged and replaced by a wooden barrel still to be treated. Consequently, there is a need to provide a dust suction and treatment system, which adds an overhead to the installation and operating costs.

According to another drawback, this treatment method generates a significant volume of treatment residues which cannot be recovered or partially reused. Thus, at the end of the treatment, the silica-based abrasive, mixed with the rest of the residues, cannot be reused. Consequently, this treatment method consumes a large quantity of abrasive and generates a large quantity of waste, which tends to add an overhead to the wooden barrel treatment costs.

### SUMMARY OF THE INVENTION

The present invention aims to remedy all or part of the drawbacks of the prior art.

To this end, the subject of the invention is a method for treating wooden barrels comprising an inside surface on which there is a degraded layer, the treatment method comprising spraying an abrasive against at least a part of the inside surface of the wooden barrel in order to remove the degraded layer.

According to the invention, the treatment method comprises using a grit-based and/or slag-based abrasive and comprises a step of sorting of the treatment residues resulting from the removal of the degraded layer in order to separate the grit and/or the slag from the other residues.

Also a subject of the invention is a device for treating wooden barrels comprising a spraying system configured to spray an abrasive against the inside surface of a wooden barrel, characterized in that the spraying system is linked to a supply of grit and/or of slag and in that the device for treating wooden barrels comprises a system for sorting treatment residues configured to isolate the grit and/or the slag from the other residues in order to reintroduce them into the supply of grit and/or of slag.

### BRIEF DESCRIPTION OF THE DRAWINGS

Other features and advantages will emerge from the following description of the invention, a description given purely by way of example, in light of the attached drawings in which:

FIG. 1 is a cross section of a part of a new wooden barrel,

FIG. 2 is a cross section of a part of a wooden barrel having an altered inside surface,

FIG. 3 is a cross section of the part of the wooden barrel visible in FIG. 2 during treatment,

FIG. 4 is a cross section of the part of the wooden barrel visible in FIG. 2 at the end of the restoration treatment,

FIG. 5 is a schematic representation of a device for treating a wooden barrel which illustrates an embodiment of the invention at a first instant of the treatment,

FIG. 6 is a schematic representation of the device for treating a wooden barrel visible in FIG. 5 at a second instant in the treatment,

FIG. 7 is a schematic representation of a device for treating wooden barrels which illustrates an embodiment of the invention,

FIG. 8 is a schematic representation of a first phase of a treatment of the residues resulting from the restoration treatment of at least one wooden barrel which illustrates an embodiment of the invention,

FIG. 9 is a schematic representation of a second phase of a treatment of the residues resulting from the restoration treatment of at least one wooden barrel which illustrates another embodiment of the invention,

FIG. 10 is a schematic representation of a system for treating residues resulting from the restoration treatment of at least one wooden barrel which illustrates another embodiment of the invention.

### DETAILED DESCRIPTION OF THE PREFERRED EMBODIMENTS

According to an embodiment visible in FIGS. 5 to 7, a wooden barrel 10 comprises a body 12 that is open at both ends, and two bottoms 14 closing the two ends of the body 12. According to one configuration, the body 12 has an axis of revolution A12 and a main inside surface. Each bottom 14 is positioned in a transverse plane, at right angles to the axis of revolution A12, and has a secondary inside surface. Thus, the sum of the main and secondary inside surfaces forms the inside surface F10 of the wooden barrel 10.

Whatever the embodiment, the wooden barrel 10 comprises at least one orifice 16 allowing the inside of the wooden barrel 10 to communicate with the outside. This orifice 16 is also called a bung hole. As an indication, this orifice 16 has a diameter of the order of 40 mm This orifice 16 allows the wooden barrel to be filled with a liquid to be stored, or to be drained. According to one configuration, the orifice 16 is positioned on the body 12, equidistant from the bottoms 14. However, the invention is not limited to that position. Thus, the orifice 16 could be positioned on one of the bottoms 14.

The wooden barrel 10 is not described further because it is known to the person skilled in the art.

To age wine, the inside surface F10 of the wooden barrel 10 is heated, by a prior art heating method in order to allow the wood to transfer certain aromas or substances to the wine. The inside surface F10 is affected by the heating to a depth of a few millimeters, of the order of 5 mm This heating zone is represented by cross-hatching and referenced 18 in FIGS. 1 to 4.

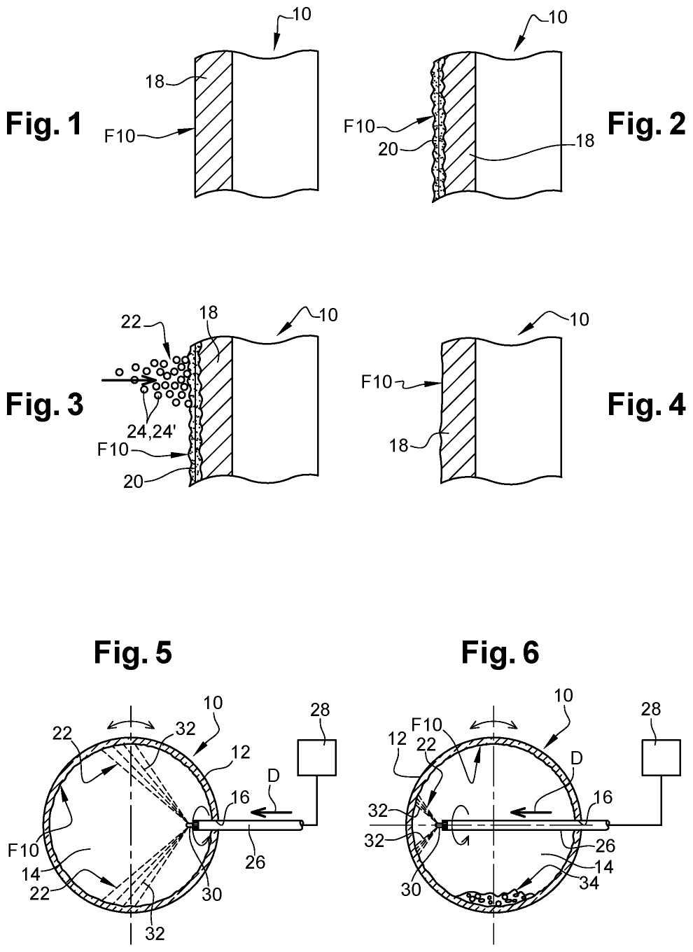

After having contained one or more wines, the inside surface F10 of the wooden barrel 10 is altered on the surface, to a depth of a few millimeters, by microorganisms and by mineral or organic deposits, this alteration being embodied by a degraded layer 20 in FIGS. 2 and 3.

To remove this degraded layer 20, the wooden barrel 10 is treated by spraying an abrasive 22 against at least a part of the inside surface F10, preferably over the entire inside surface F10, as illustrated in FIG. 3. At the end of the treatment, the degraded layer 20 is removed so that the heating surface 18 is once again cleared, as illustrated in FIG. 4.

According to the invention, the abrasive 22 is based on grit 24 and/or slag 24′.

According to a first embodiment, the abrasive 22 consists essentially of grit 24, in the form of metal balls, for example.

According to one configuration, the metal balls have a diameter of between 0.1 and 10 mm. To avoid compacting the inside surface F10 of the wooden barrel, the metal balls have a diameter less than or equal to 2 mm. To avoid the metal balls embedding in the wood, the metal balls have a diameter greater than or equal to 0.5 mm.

Preferably, the grit 24 is a magnetizable material.

According to one embodiment, the grit 24 is made of stainless steel.

According to a second embodiment, the abrasive 22 consists essentially of slag 24′ in the form of hard, angular non-metallic granules, produced in the production of steel in blast furnaces, for example. According to one configuration, this slag 24′ is marketed under the name Scorex. This type of material has a very low metal content. It is a non-hazardous material, free of crystalline silica.

The slag 24′ has a hardness greater than or equal to 6 Mohs.

Like the grit 24, the slag 24′ has a granule size of between 0.5 and 2 mm, preferably between 0.5 and 1.6 mm to avoid the compacting of the inside surface F10 of the wooden barrel and to avoid the slag 24′ embedding in the wood.

The grit 24 and/or the slag 24′ is sprayed with a fluid, such as water and/or air, with an abrasive percentage of the order of 15 to 40%. The grit 24 and/or the slag 24′ is sprayed at a given ejection speed below a first threshold in order to avoid the compacting of the wood on the inside surface F10 and above a second threshold in order to obtain the removal of the degraded layer 20. According to one embodiment, the speed of ejection of the grit 24 and/or of the slag 24′ is greater than 25 m/s.

According to one procedure, the abrasive is sprayed against the inside surface F10 of the wooden barrel 10 using a hose 26 linked to a supply 28 of grit and/or of slag and introduced partially into the wooden barrel 10 via the orifice 16. This hose 26 has, at one of its ends, at least one nozzle 30 allowing at least one abrasive jet 32 to be formed. The hose 26 is set in motion and/or the wooden barrel 10 is set in motion in order for the jets 32 to sweep the entire inside surface F10. According to one embodiment, the hose 26 is translated in a direction D and pivots on itself and/or the wooden barrel 10 is rotated about its axis of revolution A12.

The spraying system described in the document WO 2007125250 can be used to spray the abrasive in the form of grit and/or slag.

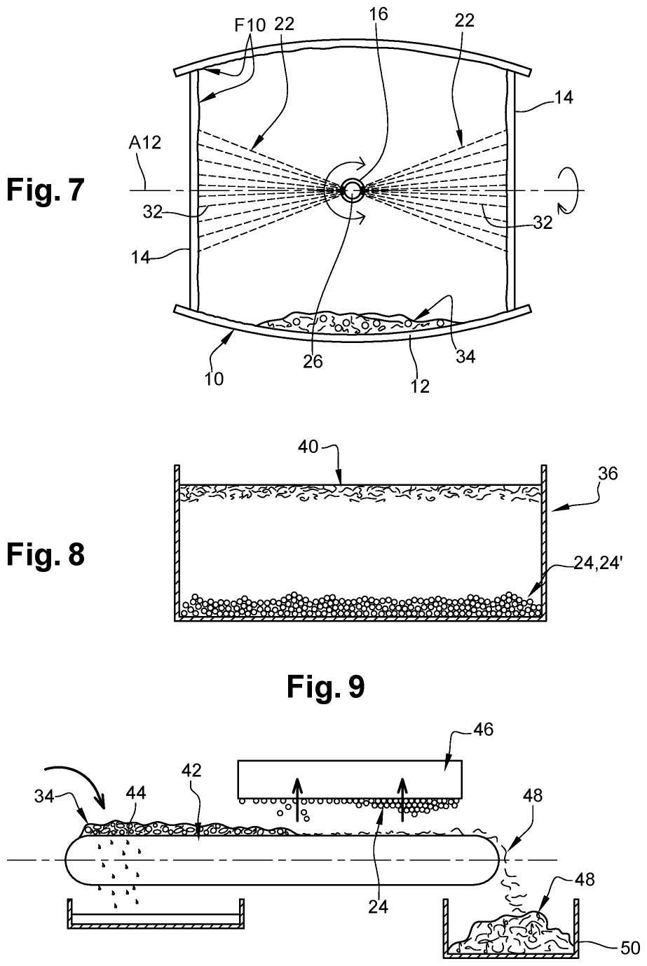

The method for treating the wooden barrel 10 generates treatment residues 34 such as the abrasive, the deposits, the microorganisms, etc., as illustrated in FIGS. 6 and 7. These treatment residues 34 are removed from the wooden barrel, via the orifice 16, by gravity and/or rinsing with a liquid such as cold water, for example.

According to another procedure, the grit 24 and/or the slag 24′ is sprayed with air and the treatment residues 34 are removed from the wooden barrel 10 by dry suction.

According to a particular feature of the invention, the treatment method comprises a step of sorting of the treatment residues 34 in order to separate the grit 24 and/or slag 24′ from the other residues, this sorting step coming after the step of treatment of the wooden barrels 10. At the end of the sorting step, the grit 24 and/or the slag 24′ isolated from rest of the residues is reused for the method for treating wooden barrels and reintroduced into the supply 28 of grit and/or of slag.

In addition to the system for spraying the abrasive 22, the device for treating wooden barrels comprises a system for sorting treatment residues 34 configured to isolate the grit 24 and/or the slag 24′ from the other residues. In addition, it comprises a conveying system for reintroducing the grit 24 and/or the slag 24′ isolated by the sorting system into the supply 28 of grit and/or of slag.

According to one procedure, the sorting step comprises a phase of sorting by decantation, as illustrated in FIG. 8. In this case, the mixture of water and of treatment residues 34 leaving at least one wooden barrel 10 is poured into a container 36. The grit 24 and/or the slag 24′ have a density significantly higher than most of the other residues 40, so they are deposited at the bottom of the container 36 whereas most of the other residues 40 float on the surface of the water. Next, the floating residues 40 are removed and then the mixture of water, grit 24 and/or slag 24′ is drained so as to isolate the grit 24 and/or the slag 24′ which, after drying, is then reintroduced into the supply 28 of grit and/or of slag to be used once again for the restoration treatment of other wooden barrels.

According to one procedure, the sorting step comprises a phase of sorting by magnetization, as illustrated in FIG. 9, the grit 24 being made of a magnetizable material. In this case, the mixture of water and of treatment residues 34 leaving at least one wooden barrel 10 is poured onto a conveyor 42 which has a grating 44 allowing the mixture to be drained. Next, the treatment residues 34, drained and deposited on the conveyor 42, pass under a magnetization system 46 such that the grit 24 is magnetized and that only the other residues 48 remain on the conveyor 42 to be poured into a container 50. The magnetized grit 24, separated from the other residues 48, is then reintroduced into the supply 28 of grit to be used again for the restoration treatment of other wooden barrels.

The phase of sorting by magnetization is in no way limited to the embodiment described above. As a variant, the conveyor 42 is magnetized in order to retain the grit 24. In this case, at the end of the conveyor 42, the other residues 48 fall into a container 50 and the grit 24 remains against the bottom belt of the conveyor 42. A scraper positioned under the conveyor, in contact with the bottom belt of the conveyor 42, is then used to detach the grit 24 from the conveyor 42 in order to recover it and reintroduce it into the supply 28 of grit.

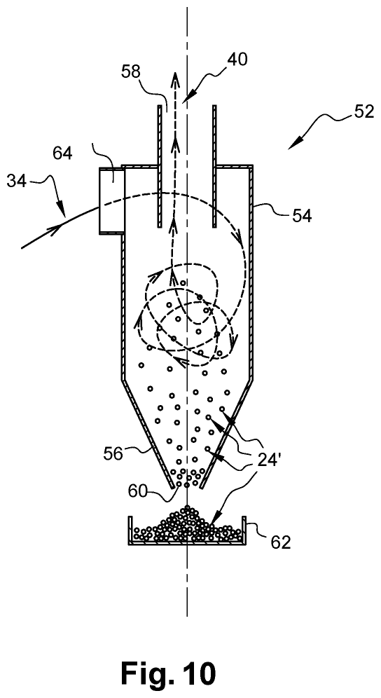

According to one procedure, the sorting step comprises a phase of cyclonic separation, as illustrated in FIG. 10, the slag 24′ having a density significantly higher than most of the other residues 40. Thus, after having been sucked out dry, the treatment residues 34 are sucked in and treated by a cyclone 52. The latter has a cylindrical chamber 54, a tapered bottom part 56 and a top outlet 58. The tapered bottom part 56 has a bottom outlet 60 for the slag 24′ positioned above a collection tank 62. The cyclone 52 has an inlet 64 positioned in the top part of the cylindrical chamber 54 and it is configured for a strong suction at the top outlet 60 to generate a vortex of the treatment residues 34 inside the cyclone 52, causing the slag 24′ to drop via the bottom outlet 60 and the other residues to be sucked out via the top outlet 58. In addition to the cyclone 52, the device for treating wooden barrels comprises a system for dry suction of the treatment residues 34 to extract them from the wooden barrel 10.

The dry suction of the treatment residues 34 followed by the step of sorting by cyclonic separation makes it possible to obtain a cost-effective recycling of the slag 24′.

The phases of sorting by decantation and by magnetization can be combined. In this case, the phase of sorting by decantation is performed before the phase of sorting by magnetization. As a general rule, the different sorting techniques can be combined.

The use of grit and/or of slag as abrasive for the residue treatment method makes it possible to be able to reuse the abrasive and to reduce the wooden barrel treatment costs as well as the quantity of waste.

It also makes it possible to reduce the quantity of dust produced in the treating of the wooden barrels.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-13. (canceled)

14. A method for treating a wooden barrel comprising an inside surface on which there is a degraded layer, the treatment method comprising spraying an abrasive against at least a part of the inside surface of the wooden barrel to remove the degraded layer, wherein the treatment method comprises:
using at least one of a grit-based or slag-based abrasive,
sorting treatment residues resulting from a removal of the degraded layer to separate the at least one of the grit-based or the slag-based abrasive from other residues.

15. The method for treating the wooden barrel as claimed in claim 14, wherein the sorting step comprises a step of sorting by magnetization, the grit-based abrasive being of a magnetizable material.

16. The method for treating the wooden barrel as claimed in claim 14, wherein the sorting step comprises a step of sorting by decantation, the at least one of the grit -based or slag-based abrasive having a density significantly higher than most of the other residues.

17. The method for treating the wooden barrel as claimed in claim 15,
wherein the sorting step comprises a step of sorting by decantation, the at least one of the grit-based or slag-based abrasive having a density significantly higher than most of the other residues and
wherein the step of sorting by decantation is performed before the step of sorting by magnetization.

18. The method for treating the wooden barrel as claimed in claim 14, wherein the grit-based abrasive comprises metal balls made of stainless steel.

19. The method for treating the wooden barrel as claimed in claim 14,
wherein the abrasive is composed essentially of slag, and
wherein the sorting step includes a cyclonic separation phase.

20. The method for treating the wooden barrel as claimed in claim 19, wherein the treatment residues are extracted from the wooden barrel by dry suction prior to the sorting step.

21. The method for treating the wooden barrel as claimed in claim 14, wherein a speed of ejection of the at least one of the grit-based or the slag-based abrasive is greater than 25 m/s.

22. The method for treating the wooden barrel as claimed in claim 14, wherein the at least one of the grit-based or the slag-based abrasive has a particle size of between 0.5 and 2 mm.

23. A device for treating a wooden barrel comprising:
a spraying system configured to spray an abrasive against an inside surface of a wood barrel,
wherein the spraying system is linked to a supply of at least one of grit or of slag, and
wherein the device for treating the wooden barrel comprises a system for sorting treatment residues configured to isolate the at least one of grit or slag from other residues to reintroduce the at least one of the grit or slag into the supply of at least one of grit or slag.

24. The device for treating the wooden barrel as claimed in claim 23, further comprising a conveying system for reintroducing the at least one of grit or slag isolated by the sorting system into the supply of at least one of grit or slag.

25. The device for treating the wooden barrel as claimed in claim 23, further comprising a cyclone configured to generate a vortex of the treatment residues causing the slag to be dropped via a bottom outlet and the other residues to be sucked out via a top outlet.

26. The device for treating the wooden barrel as claimed in claim 25, further comprising a system for dry suction of the treatment residues to extract the treatment residues from the wooden barrel.
